(19) United States
(12) Patent Application Publication
(10) Pub. No.: US 2021/0300190 A1
(43) Pub. Date: Sep. 30, 2021

(54) PARKING SUPPORT SYSTEM

(71) Applicant: HONDA MOTOR CO., LTD., Tokyo (JP)

(72) Inventor: Takuya Iwamoto, Wako-shi (JP)

(21) Appl. No.: 17/207,776

(22) Filed: Mar. 22, 2021

(30) Foreign Application Priority Data
Mar. 26, 2020 (JP) 2020-056116

(51) Int. Cl. B60L 53/12; B60W 60/00; H02J 50/10; H02J 50/90

(52) U.S. Cl. CPC B60L 53/12; H02J 50/90; H02J 50/10; B60W 60/0025

(57) ABSTRACT

A parking support system that can curb competition between non-contact charging and other support operations when a vehicle is parked is provided. A parking support system 10 includes a power receiving device 11, an object detection device 15, a vehicle control unit 31, an acoustic device 17, a display device 19 and a driving unit 21. The power receiving device 11 includes a power receiving unit 11a for receiving power transferred in a non-contact manner from a power transmission unit installed in a power supply area outside a vehicle. The vehicle control unit 31 supports alignment of a relative position of the power receiving unit 11a with respect to the power transmission unit. The vehicle control unit 31 supports the vehicle to avoid contact with an external object of the power supply area and changes the contact avoidance support operation according to the relative position of the power receiving unit 11a with respect to the power transmission unit.

### CROSS-REFERENCE TO RELATED APPLICATION

Priority is claimed on Japanese Patent Application No. 2020-056116, filed Mar. 26, 2020, the content of which is incorporated herein by reference.

### BACKGROUND OF THE INVENTION

### Field of the Invention

The present invention relates to a parking support system.

### Description of Related Art

Conventionally, a wireless power supply system that prompts parking at a reference position by detecting a deviation between the reference position and the parking position of the vehicle, and when the vehicle is parked at the reference position, transmits power from a power transmission coil disposed in a parking area to a power receiving coil of the vehicle is known (for example, refer to Patent Literature 1 (Japanese Unexamined Patent Application, First Publication No. 2015-113600)).

Conventionally, a charging support device that sets the ideal position where the battery of a vehicle can be charged while avoiding obstacles on the basis of the positions of a power supply unit in a parking frame and the obstacles around the parking frame, and notifies an occupant of a charging efficiency at the ideal position is known (refer to Patent Literature 2 (Japanese Unexamined Patent Application, First Publication No. 2011-217460)).

### SUMMARY OF THE INVENTION

Incidentally, in the system and the device described above, if other vehicle controls such as the control of avoiding contact with an object and automatic parking control of the vehicle compete with respect to control of alignment between the power transmitting side and the power receiving side required for wireless charging of the vehicle, it may not be possible to secure the desired alignment.

An object of the present invention is to provide a parking support system that can curb competition between non-contact charging and other support operations when a vehicle is parked.

A parking support system according to the present invention has adopted the following configuration.

(1): A parking support system (for example, the parking support system 10 in the embodiment) according to an aspect of the present invention includes a power receiving device (for example, the power receiving device 11 in the embodiment) that includes a power receiving unit (for example, the power receiving unit 11a in the embodiment) for receiving power transferred in a non-contact manner from a power transmission unit (for example, the power transmission unit 4 in the embodiment) installed in a power supply area (for example, the power supply area PA in the embodiment) outside a vehicle (for example, the vehicle V in the embodiment), an alignment support device (for example, the vehicle control unit 31 in the embodiment) configured to support alignment of a relative position of the power receiving unit with respect to the power transmission unit, and an avoidance support device (for example, the object detection device 15, the acoustic device 17, the display device 19, the driving unit 21, the HMI control device 35, and the traveling control device 37 in the embodiment) configured to support the vehicle to avoid contact with an external object of the power supply area and to change the contact avoidance support operation according to the relative position.

(2): In the parking support system according to the aspect of (1), the avoidance support device may include an object detection unit (for example, the object detection device 15 in the embodiment) configured to detect the object, a notification unit (for example, the acoustic device 17 and the display device 19 in the embodiment) configured to provide notification to a driver of the vehicle according to a detection result of the object by the object detection unit, and a control unit (for example, the HMI control device 35 in the embodiment) configured to change at least one of an effective detection range of the object detection unit and a threshold value for changing a notification operation of the notification unit according to a distance to the object according to the relative position.

(3): In the parking support system according to the aspect of (1) or (2), the avoidance support device may change an operating range of a brake device (for example, the brake device 25 in the embodiment) of the vehicle according to the relative position when the brake device is automatically operated as the contact avoidance support operation.

(4): In the parking support system according to the aspect of (3), the alignment support device may include a parking area acquisition unit (for example, the parking area acquisition unit 33b in the embodiment) configured to acquire a parking area indicating an area in the power supply area in which the vehicle is parked, an allowable range setting unit (for example, the allowable range setting unit 33c in the embodiment) configured to set an allowable range indicating a deviation range of a parking position of the vehicle that is allowed at the time of alignment of the relative position, a target position setting unit (for example, the target position setting unit 37a in the embodiment) configured to set a target parking position on the basis of the parking area and the allowable range, and a movement support unit (for example, the movement support unit 37b in the embodiment) configured to support an automatic movement of the vehicle to the target parking position.

According to the aspect of (1), it is possible to cause a vehicle to safely park while supporting an appropriate alignment of the power transmission unit and the power receiving unit by including the avoidance support device that changes a contact avoidance support operation according to the relative positions of the power transmission unit and the power receiving unit. For example, even if there is an obstacle such as a wall in a parking lot or the like around a power supply area, it is possible to prevent the contact avoidance support operation from being excessively executed, and to ensure a desired alignment of the power receiving unit and the power transmission unit.

According to the aspect of (2), it is possible to ensure a desired alignment of the power transmission unit and the power receiving unit without confusing a driver by including a control unit configured to change at least one of an effective detection range of the object detection unit and a threshold value of a notification operation of the notification unit according to the relative positions of the power transmission unit and the power receiving unit. For example, even if there is an obstacle such as a wall in the parking lot or the like around the power supply area, it is possible to curb detection of the obstacle and execution of a strong warning to the driver before the alignment of the power transmission unit and the power receiving unit is completed.

According to the aspect of (3), it is possible to prevent the brake device from excessively operating before the alignment of the power transmission unit and the power receiving unit is completed, and to ensure the desired alignment of the power transmission unit and the power receiving unit by including the avoidance support device configured to change an automatic operating range of the brake device according to the relative positions of the power transmission unit and the power receiving unit. For example, even if there is an obstacle such as a wall in the parking lot or the like around the power supply area, it is possible to avoid contact with the obstacle and to ensure the desired alignment of the power transmission unit and the power receiving unit by appropriately changing the operating range of the brake device.

According to the aspect of (4), it is possible to cause a vehicle to automatically park in an allowable range within a parking area and to ensure the desired alignment of the power transmission unit and the power receiving unit by including the target position setting unit configured to set a target parking position on the basis of the parking area and the allowable range.

### BRIEF DESCRIPTION OF THE DRAWINGS

FIG. 1 is a diagram which shows a configuration of a non-contact power transfer system including part of a parking support system according to an embodiment of the present invention.

FIG. 2 is a diagram which shows a configuration of the parking support system according to the embodiment of the present invention.

FIG. 3 is a diagram which shows an example of an operation of the parking support system according to the embodiment of the present invention.

FIG. 4 is a diagram which shows another example of the operation of the parking support system according to the embodiment of the present invention.

### DETAILED DESCRIPTION OF THE INVENTION

Hereinafter, a parking support system according to an embodiment of the present invention will be described with reference to the appended drawings.

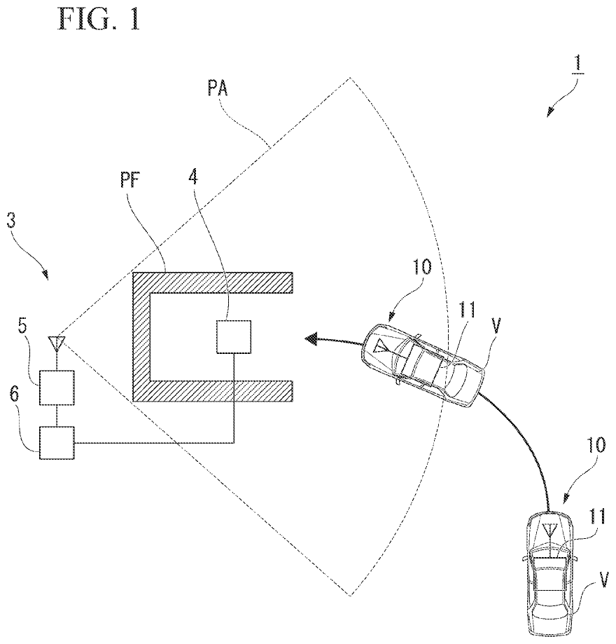

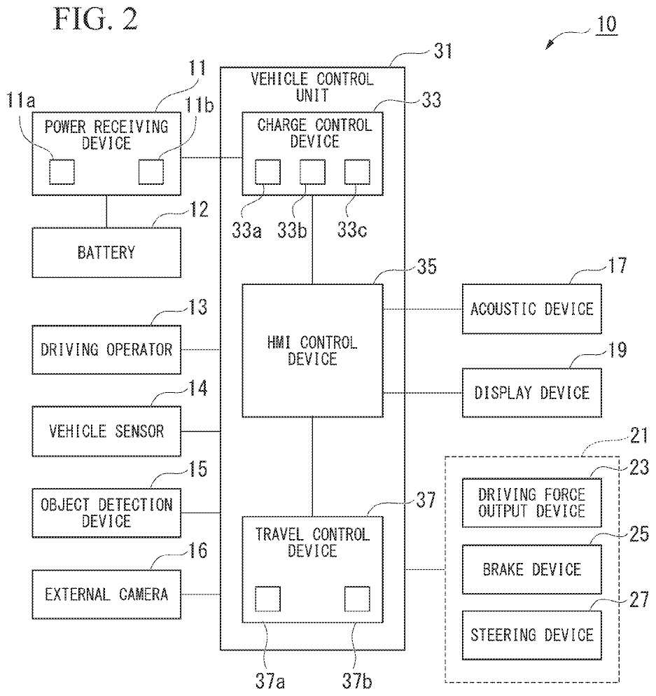

FIG. 1 is a diagram which shows a configuration of a non-contact power transfer system 1 including part of a parking support system 10 according to the embodiment. FIG. 2 is a diagram which shows a configuration of the parking support system 10 according to the embodiment.

The parking support system 10 of the embodiment is mounted in the vehicle V. The parking support system 10 includes, for example, a power receiving device 11 to be described below as part of the non-contact power transfer system 1 for charging a power storage device (for example, a battery 12 to be described below) by power transfer in a non-contact manner.

[Non-Contact Power Transfer System]

The non-contact power transfer system 1 of the embodiment includes, for example, a power transmission device 3 installed outside the vehicle V and a power receiving device 11 mounted in the vehicle V.

The power transmission device 3 includes, for example, a power transmission unit 4, a power transmission-side communication unit 5, and a power transmission-side control unit 6. The power transmission unit 4 is installed in, for example, a predetermined power supply area PA set on a road surface of a parking lot or the like. An outer shape of the power transmission unit 4 is, for example, a pad type. The power transmission unit 4 includes, for example, a primary coil, a power converter, and the like connected to a power source.

The power transmission-side communication unit 5 includes an antenna or the like for wireless communication, and automatically performs wireless communication with, for example, the power receiving device 11 in the predetermined power supply area PA. The power transmission-side control unit 6 controls operations of the power transmission unit 4 and the power transmission-side communication unit 5.

The power receiving device 11 includes, for example, a power receiving unit 11a and a power receiving-side communication unit 11b.

The outer shape of the power receiving unit 11a is, for example, a pad type. The power receiving unit 11a includes, for example, a secondary coil, a rectifier, and the like connected to the battery 12. The power receiving unit 11a receives power according to a change in a high frequency magnetic field transmitted from the power transmission unit 4 by magnetic field coupling such as magnetic field resonance or electromagnetic induction at, for example, a predetermined relative position with respect to the power transmission unit 4 of the power transmission device 3.

The power receiving-side communication unit 11b includes an antenna or the like for wireless communication, and performs, for example, pairing such as authentication using a unique identifier or the like registered in advance and, at the same time, transmits or receives various types of information by an automatic wireless communication connection to the power transmission-side communication unit 5 of the power transmission device 3.

The power receiving device 11 is controlled by the charging control device 33 provided in the vehicle control unit 31 to be described below.

[Parking Support System]

The parking support system 10 of the embodiment includes, for example, the power receiving device 11, the battery 12, a driving operator 13, a vehicle sensor 14, an object detection device 15, an external camera 16, an acoustic device 17, a display device 19, a driving unit 21, and a vehicle control unit 31.

The battery 12 is, for example, a lithium ion battery. The battery 12 is connected to the power receiving unit 11a of the power receiving device 11. The battery 12 is charged by power transferred from the power transmission device 3 outside the vehicle V via the power receiving unit 11a in a non-contact manner.

The driving operator 13 is an operator such as an accelerator pedal, a brake pedal, a shift lever, and a steering wheel. The driving operator 13 includes, for example, a sensor that detects an amount of operations or a presence or absence of operations of each operator. Each sensor outputs a signal corresponding to a detection result to at least one of a traveling control device 37, a driving force output device 23, a brake device 25, and a steering device 27, which will be described below.

The vehicle sensor 14 is, for example, a vehicle speed sensor that detects a vehicle speed, an acceleration sensor that detects an acceleration of the vehicle V, and a yaw rate sensor that detects an angular speed around a vertical axis of the vehicle V. Each sensor outputs the signal corresponding to a detection result to the vehicle control unit 31.

The object detection device 15 includes, for example, at least one of a sonar, a radar device, a finder, and the like.

Each of the sonar, the radar device, and the finder emits ultrasonic waves, electromagnetic waves, and light around the vehicle V, and detects a distance or a position to an object by detecting reflection or scattering by the object. The finder is, for example, a light detection and ringing or laser imaging detection and ringing (LIDAR) sensor.

The object detection device 15 outputs information on a result of the detection to the vehicle control unit 31.

The external camera 16 is, for example, a digital camera including a solid-state imaging element such as a charge coupled device (CCD) or a complementary metal oxide semiconductor (CMOS). The external camera 16 outputs image data obtained by imaging an external world of the vehicle V in a visible light region and an infrared region to the vehicle control unit 31.

The acoustic device 17 includes, for example, a speaker, a buzzer, and the like.

The display device 19 includes, for example, a multi-information display configured by a liquid crystal display, an organic EL display, or the like, a display audio touch panel, or the like.

The driving unit 21 includes, for example, the driving force output device 23, the brake device 25, and the steering device 27.

The driving force output device 23 outputs a traveling driving force (torque) for traveling of the vehicle V to the drive wheels. The driving force output device 23 includes, for example, a combination of an internal combustion engine, an electric motor, a transmission, and the like, and an electronic control unit (ECU) that controls these. The ECU controls the traveling driving force according to information input from the traveling control device 37 or information input from the driving operator 13.

The brake device 25 includes, for example, a brake caliper, a cylinder that transmits a hydraulic pressure to the brake caliper, an electric motor that causes the cylinder to generate a hydraulic pressure, and a brake ECU. The brake ECU controls the electric motor according to the information input from the traveling control device 37 or the information input from the driving operator 13, and outputs a brake torque according to a braking operation to each wheel. The brake device 25 includes, for example, a mechanism for transmitting a hydraulic pressure generated by an operation of a brake pedal of the driving operator 13 to the cylinder via a master cylinder in addition to a hydraulic pressure generated by the electric motor. The brake device 25 is not limited to the configuration described above and may control an actuator according to the information input from the traveling control device 37 to transmit the hydraulic pressure of the master cylinder to the cylinder.

The steering device 27 includes, for example, a steering ECU and an electric motor. The electric motor, for example, applies a force to a rack and pinion mechanism and changes a direction of a steering wheel. The steering ECU drives the electric motor according to the information input from the traveling control device 37 or the information input from the driving operator 13 and changes the direction of the steering wheel.

The vehicle control unit 31 includes, for example, a charging control device 33 that controls the power receiving device 11, an HMI control device 35 that controls the acoustic device 17 and the display device 19, and a traveling control device 37 that controls the driving unit 21. Each control device is, for example, a software functional unit that functions when a predetermined program is executed by a processor such as a central processing unit (CPU). The software functional unit is an ECU equipped with electronic circuits such as a processor such as a CPU, a read only memory (ROM) for storing a program, a random access memory (RAM) for temporarily storing data, and a timer. At least part of the vehicle control unit 31 may be an integrated circuit such as large scale integration (LSI).

The charging control device 33 supports an alignment of a relative position of the power receiving unit 11a of the power receiving device 11 with respect to the power transmission unit 4 of the power transmission device 3. The charging control device 33 includes, for example, a relative position detection unit 33a, a parking area acquisition unit 33b, and an allowable range setting unit 33c.

The relative position detection unit 33a detects the relative position of the power receiving unit 11a with respect to the power transmission unit 4 according to, for example, a low power excitation (LPE) or low frequency (LF) signal. For example, the relative position is detected on the basis of a change in received power when low power is transferred between the power transmission unit 4 and the power receiving unit 11a in the LPE signal. For example, the relative position is detected on the basis of a change in reception intensity when the LF signal is transmitted and received between the power transmission-side communication unit 5 and the power receiving-side communication unit 11b in the LF signal.

For example, a receiver that acquires position coordinate information of the power transmission unit 4 from the power transmission-side communication unit 5 of the power transmission device 3 and receives a positioning signal used in a positioning system (for example, a Global Positioning System: GPS, a Global Navigation Satellite System: GNSS, or the like) may be provided in the vehicle V. In this case, the charging control device 33 may detect the relative position of the power receiving unit 11a with respect to the power transmission unit 4 on the basis of the position coordinate information of the power transmission unit 4 and position information of the vehicle V obtained from the positioning signal.

The parking area acquisition unit 33b acquires information on a parking area indicating an area in the power supply area PA in which the vehicle V is parked. The parking area acquisition unit 33b acquires, for example, information of a parking frame PF set to surround the vehicle V in the power supply area PA as the information on a parking area. The parking area acquisition unit 33b acquires, for example, positional information of the parking frame PF from the power transmission-side communication unit 5 of the power transmission device 3 via the power receiving-side communication unit 11b. Alternatively, the parking area acquisition unit 33b acquires a position of the parking frame PF according to, for example, image recognition processing for image data output from the external camera 16.

The allowable range setting unit 33c sets an allowable range that indicates a range of deviation of a parking position of the vehicle V that is allowed to ensure desired power transfer efficiency when the relative position of the power receiving unit 11a with respect to the power transmission unit 4 is aligned.

The HMI control device 35 controls various devices mounted in the vehicle V according to a detection signal and an operation signal output from various sensors and input devices mounted in the vehicle V. Various devices mounted in the vehicle V include an acoustic device 17, a display device 19, a navigation device, and the like.

The traveling control device 37 controls the driving force output device 23, the brake device 25, and the steering device 27 according to signals output from the driving operator 13, the vehicle sensor 14, the object detection device 15, the external camera 16, various sensors mounted in the vehicle V, and the like. The traveling control device 37 controls, for example, traveling support operations of the vehicle V such as automatic parking, cruise control, and lane maintenance assistance. Automatic parking is, for example, a control for automatically moving the vehicle V to a predetermined parking position. Cruise control is, for example, a control of constant speed traveling that keeps a vehicle speed of the vehicle V constant and follow-up traveling that keeps a distance between the vehicle V and a preceding vehicle constant. Lane maintenance assist is a control that supports the vehicle V to travel in the center of a lane.

At least one of the HMI control device 35 and the traveling control device 37 supports the alignment of a relative position of the power receiving unit 11a of the power receiving device 11 with respect to the power transmission unit 4 of the power transmission device 3 when power is transferred in a non-contact manner by the non-contact power transfer system 1.

The HMI control device 35 guides, for example, a movement of the vehicle V according to the acoustic device 17 and the display device 19 such that the relative position of the power receiving unit 11a with respect to the power transmission unit 4 detected by the charging control device 33 becomes a predetermined relative position required for the desired power transfer.

The traveling control device 37 includes, for example, a target position setting unit 37a and a movement support unit 37b.

The target position setting unit 37a sets a target parking position PT on the basis of information on a parking area (for example, information on the parking frame PF) acquired by the parking area acquisition unit 33b of the charging control device 33 and an allowable range set by the allowable range setting unit 33c of the charging control device 33. The target parking position PT is set to, for example, a region smaller than the parking frame PF in the parking frame PF, and is a position where a desired power transfer efficiency is ensured between the power transmission unit 4 and the power receiving unit 11a.

The movement support unit 37b supports an automatic movement of the vehicle V to the target parking position PT set by the target position setting unit 37a under a control of the driving unit 21.

At least one of the HMI control device 35 and the traveling control device 37 supports the vehicle V to avoid contact with a person and an object existing outside the vehicle V. The HMI control device 35 and the traveling control device 37 control, for example, a notification to a driver by the acoustic device 17 and the display device 19 and automatic braking by the brake device 25 as a support operation for the vehicle V avoiding contact with an external object detected by the object detection device 15.

The HMI control device 35 and the traveling control device 37 change the support operation for contact avoidance according to a relative position in a state of executing the alignment of the relative position of the power receiving unit 11a with respect to the power transmission unit 4 when the non-contact power transfer is executed by the non-contact power transfer system 1.

The HMI control device 35 changes, for example, at least one of an effective detection range of the object detection device 15 and a threshold value for changing a notification operation by the acoustic device 17 and the display device 19 according to a distance to an object to a relaxation tendency according to the relative position.

For example, when the traveling control device 37 automatically operates the brake device 25 of the vehicle V with respect to an object, an operating range of the brake device 25 is changed to the relaxation tendency according to the relative position.

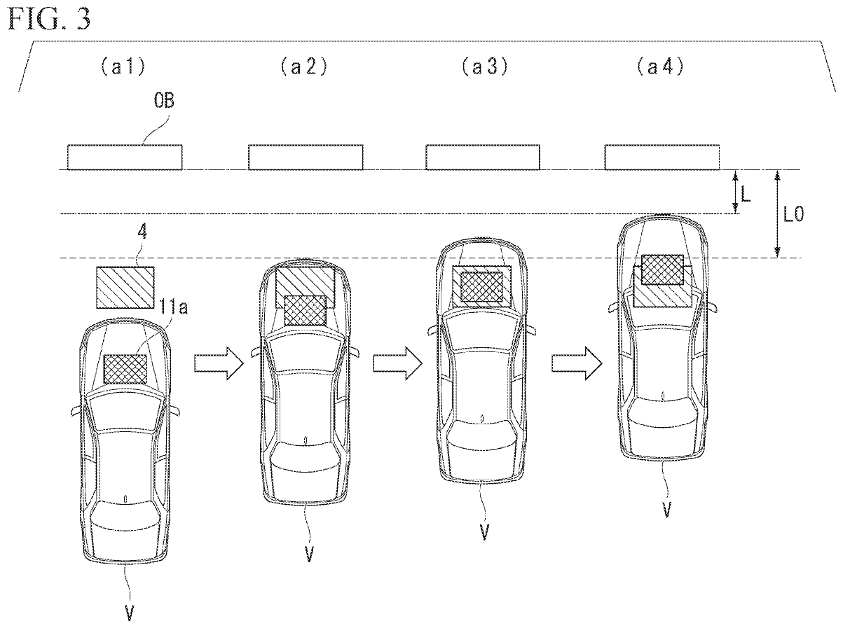

FIG. 3 is a diagram which shows an example of an operation of the parking support system 10 of the embodiment. The example shown in FIG. 3 shows a state in which an object OB is present in front of the vehicle V in a traveling direction at the time at which the relative position of the power receiving unit 11a is aligned with the power transmission unit 4 according to movement of the vehicle V when the non-contact power transfer is executed by the non-contact power transfer system 1.

For example, the HMI control device 35 stores a predetermined threshold value for changing a notification operation according to a distance from the vehicle V to the object OB detected by the object detection device 15. At the time at which the HMI control device 35 executes a notification operation by the acoustic device 17 or the display device 19 with the vehicle V approaching the object OB, the HMI control device 35 performs a notification with a first level of intensity when the distance from the vehicle V to the object OB is larger than the predetermined threshold value. When the distance from the vehicle V to the object OB is equal to or less than the predetermined threshold value, the HMI control device 35 performs a notification with a second level intensity, which is higher than the first level. For example, the notification with the first-level of intensity is a notification that calls attention without prompting stopping of the vehicle V, and the notification with the second-level of intensity is a notification that prompts stopping of the vehicle V. For example, in the case of a notification sound, a magnitude of the notification intensity is a magnitude of a volume, a frequency, or the like of the notification sound.

For example, in an initial state or the like in which the vehicle V moves toward the power transmission unit 4, as in a first state (a1) shown in FIG. 3, the HMI control device 35 executes a notification operation using a reference threshold value LO which is an initial reference value as a predetermined threshold value. That is, the HMI control device 35 performs a notification with the first level of intensity when the distance from the vehicle V to the object OB is larger than the reference threshold value LO. Then, as in a second state (a2) shown in FIG. 3, if the distance from the vehicle V to the object OB reaches the reference threshold value LO before the relative position of the power receiving unit 11a with respect to the power transmission unit 4 reaches a predetermined relative position required for a desired power transfer, the HMI control device 35 changes the predetermined threshold value in a relaxation direction. That is, the HMI control device 35 switches the reference threshold value LO to a change threshold value L smaller than the reference threshold value LO as a predetermined threshold value, and executes the notification operation. As a result, the HMI control device 35 maintains the first level of intensity and performs a notification when the distance from the vehicle V to the object OB is larger than the change threshold value L.

Then, as in a third state (a3) shown in FIG. 3, if the relative position of the power receiving unit 11a with respect to the power transmission unit 4 reaches the predetermined relative position required for a desired power transfer before the distance from the vehicle V to the object OB reaches the change threshold value L, the movement of the vehicle V is stopped while the notification with the first level of intensity is continued, and power transfer from the power transmission unit 4 to the power receiving unit 11a is started. As in a fourth state (a4) shown in FIG. 3, if the distance from the vehicle V to the object OB reaches the change threshold value L, the notification with the second level of intensity, which is higher than the first level, is started.

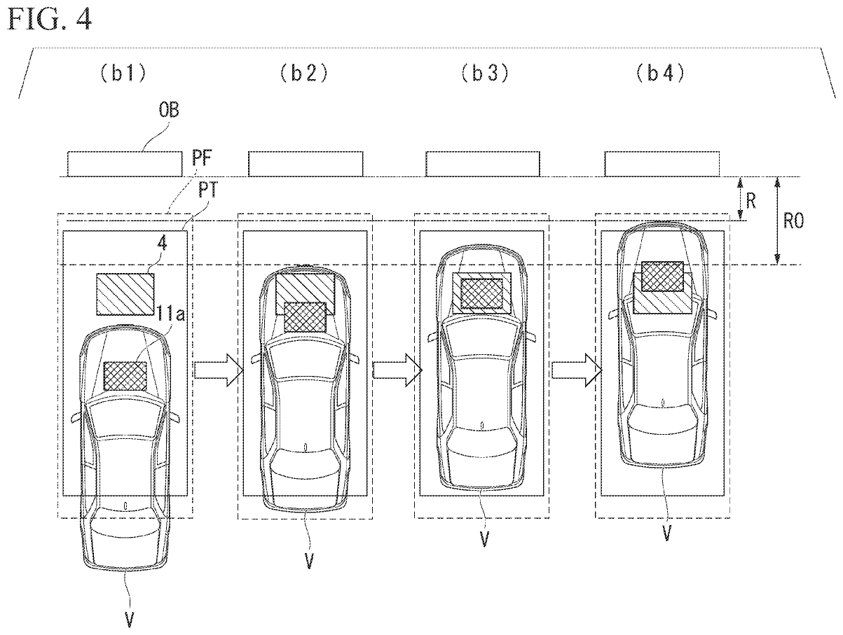

FIG. 4 is a diagram which shows another example of the operation of the parking support system 10 according to the embodiment. The example shown in FIG. 4 shows a state in which the object OB is present in front of the vehicle V in the traveling direction at the time at which the relative position of the power receiving unit 11a is aligned with the power transmission unit 4 according to the movement of the vehicle V when the non-contact power transfer is executed by the non-contact power transfer system 1.

For example, the traveling control device 37 stores a predetermined operating range for causing the brake device 25 to automatically operate to support the vehicle V to avoid contact with the object OB detected by the object detection device 15. For example, the traveling control device 37 causes the brake device 25 to automatically operate to stop the vehicle V when a relative position of the object OB with respect to the vehicle V is within the predetermined operating range while the vehicle V is approaching the object OB.

For example, in the initial state or the like in which the vehicle V moves toward the power transmission unit 4, as in the first state (b1) shown in FIG. 4, the traveling control device 37 causes the brake device 25 to automatically operate using a reference operating range R0 that is an initial reference value as the predetermined operating range. That is, the traveling control device 37 causes the brake device 25 to automatically operate when the distance from the vehicle V to the object OB is within the reference operating range R0 and prohibits the automatic operation of the brake device 25 when the distance from the vehicle V to the object OB is beyond the reference operating range R0.

Then, as in the second state (b2) shown in FIG. 4, if the distance from the vehicle V to the object OB reaches the reference operating range R0 before the relative position of the power receiving unit 11a with respect to the power transmission unit 4 reaches a predetermined relative position required for the desired power transfer, the traveling control device 37 changes the predetermined operating range in the relaxation direction. That is, the traveling control device 37 controls the brake device 25 by switching the reference operating range R0 to a changed operating range R, which is smaller than the reference operating range R0, as the predetermined operating range. As a result, the traveling control device 37 prohibits the automatic operation of the brake device 25 when the distance from the vehicle V to the object OB is beyond the changed operating range R. In the second state (b2) shown in FIG. 4, the state in which the relative position of the power receiving unit 11a has not reached the predetermined relative position is, for example, a state in which the vehicle V is in the parking frame PF but is not in an area of the target parking position PT.

Then, as in the third state (b3) shown in FIG. 4, if the relative position of the power receiving unit 11a with respect to the power transmission unit 4 reaches the predetermined relative position required for desired power transfer before the distance from the vehicle V to the object OB reaches the changed operating range R, stopping of the movement of the vehicle V is prompted, and the power transfer from the power transmission unit 4 to the power receiving unit 11a is started. In the third state (b3) shown in FIG. 4, the state in which the relative position of the power receiving unit 11a reaches the predetermined relative position is, for example, a state in which the vehicle V is in the area of the target parking position PT in the parking frame PF.

As in the fourth state (b4) shown in FIG. 4, if the distance from the vehicle V to the object OB reaches the changed operating range R, the traveling control device 37 causes the brake device 25 to automatically operate.

As described above, the parking support system 10 of the embodiment includes the HMI control device 35 and the traveling control device 37 that change the contact avoidance support operation according to the relative positions of the power transmission unit 4 and the power receiving unit 11a, thereby causing the vehicle V to safely park while supporting proper alignment of the power receiving unit 11a with respect to the power transmission unit 4. For example, even if there is an obstacle such as a wall in a parking lot or the like near the power supply area PA, it is possible to prevent the contact avoidance support operation from being excessively executed and to ensure desired alignment of the power receiving unit 11a with respect to the power transmission unit 4.

By changing at least one of the effective detection range of the object detection device 15 and the threshold value for the notification operation by the acoustic device 17 and the display device 19 according to the relative positions of the power transmission unit 4 and the power receiving unit 11a, it is possible to ensure the desired alignment of the power transmission unit 4 and the power receiving unit 11a without confusing the driver. For example, even if there is an obstacle such as a wall in the parking lot or the like near the power supply area PA, it is possible to curb detection of the obstacle and execution of a strong warning to the driver before the alignment of the power transmission unit 4 and the power receiving unit 11a is completed. As a result, for example, a contact avoidance alarm is output only when a distance between the vehicle V and the obstacle becomes close to some extent, and thereby it is possible to perform the alignment of the power transmission unit 4 and the power receiving unit 11a without confusing the driver or coming into contact with the obstacle.

By changing an automatic operating range of the brake device 25 according to the relative positions of the power transmission unit 4 and the power receiving unit 11a, it is possible to prevent the brake device 25 from excessively operating before the alignment of the power transmission unit 4 and the power receiving unit 11a is completed and to ensure the desired alignment of the power transmission unit 4 and the power receiving unit 11a. For example, even if there is an obstacle such as a wall in the parking lot or the like near the power supply area PA, it is possible to avoid contact the obstacle and to ensure the desired alignment of the power transmission unit 4 and the power receiving unit 11a by changing the operating range of the brake device 25 appropriately for the relaxation tendency.

By setting a target parking position on the basis of a parking area and an allowable range in the power supply area PA acquired by the charging control device 33, the vehicle V can be automatically parked in the allowable range within the parking area, and the desired alignment of the power transmission unit 4 and the power receiving unit 11a can be ensured. For example, in automatic parking of the vehicle V, it is possible to prevent the vehicle V from deviating from the allowable range of misalignment required for the desired power transfer even in the parking frame PF and to ensure desired power transfer efficiency.

### Modified Example

A modified example of the embodiment will be described below.

In the embodiment described above, the HMI control device 35 changes the notification intensity when the notification operation by the acoustic device 17 and the display device 19 is changed according to a predetermined threshold value, but the present invention is not limited thereto. For example, the HMI control device 35 may switch between the presence or absence of execution of the notification operation when the notification operation by the acoustic device 17 and the display device 19 is changed according to the predetermined threshold value.

In the embodiment described above, the HMI control device 35 may also narrow, for example, the effective detection range of the object detection device 15 when the effective detection range of the object detection device 15 is changed according to the relaxation tendency according to the relative position of the power receiving unit 11a with respect to the power transmission unit 4.

The embodiments of the present invention are presented as examples and are not intended to limit the scope of the invention. These embodiments can be implemented in various other forms, and various omissions, replacements, and changes can be made in a range not departing from the gist of the invention. These embodiments and modifications thereof are included in the scope and gist of the invention as well as in the scope of the invention described in the claims and the equivalent scope thereof.

### EXPLANATION OF REFERENCES

1 Non-contact power transfer system
10 Parking support system
3 Power transmission device
4 Power transmission unit
5 Power transmission-side communication unit
6 Power transmission-side control unit
11 Power receiving device
11a Power receiving unit
11b Power receiving-side communication unit
12 Battery
15 Object detection device
16 External camera
17 Acoustic device
19 Display device
21 Driving unit
23 Driving force output device
25 Brake device
27 Steering device
31 Vehicle control unit
33 Charging control device
33a Relative position detection unit
33b Parking area acquisition unit
33c Allowable range setting unit
35 HMI control device
37 Traveling control device
37a Target position setting unit
37b Movement support unit

What is claimed is:

1. A parking support system comprising:
a power receiving device that includes a power receiving unit for receiving power transferred in a non-contact manner from a power transmission unit installed in a power supply area outside a vehicle;
an alignment support device configured to support alignment of a relative position of the power receiving unit with respect to the power transmission unit; and
an avoidance support device configured to support the vehicle to avoid contact with an external object of the power supply area and to change the contact avoidance support operation according to the relative position.

2. The parking support system according to claim 1,
wherein the avoidance support device includes
an object detection unit configured to detect the object;
a notification unit configured to provide a notification to a driver of the vehicle according to a detection result of the object by the object detection unit; and
a control unit configured to change at least one of an effective detection range of the object detection unit and a threshold value for changing a notification operation of the notification unit according to a distance to the object according to the relative position.

3. The parking support system according to claim 1,
wherein the avoidance support device changes an operating range of a brake device of the vehicle according to the relative position when the brake device is automatically operated as the contact avoidance support operation.

4. The parking support system according to claim 3,
wherein the alignment support device includes
a parking area acquisition unit configured to acquire a parking area indicating an area in the power supply area in which the vehicle is parked,
an allowable range setting unit configured to set an allowable range indicating a deviation range of a parking position of the vehicle that is allowed at the time of alignment of the relative position,
a target position setting unit configured to set a target parking position on the basis of the parking area and the allowable range, and
a movement support unit configured to support automatic movement of the vehicle to the target parking position.
